(19) United States
(12) Patent Application Publication
(10) Pub. No.: US 2024/0370775 A1
(43) Pub. Date: Nov. 7, 2024

(54) INFORMATION PROCESSING APPARATUS

(71) Applicant: TOYOTA JIDOSHA KABUSHIKI KAISHA, Aichi-ken (JP)

(72) Inventors: Yusuke KIDA, Tokyo (JP); Nobuhisa OTSUKI, Tokyo (JP); Kenta TAKESHIMA, Tokyo (JP); Daichi YAMASHITA, Tokyo (JP); Hideo HASEGAWA, Tokyo (JP)

(21) Appl. No.: 18/650,082

(22) Filed: Apr. 30, 2024

(30) Foreign Application Priority Data
May 2, 2023 (JP) 2023-076104

(51) Int. Cl. G06N 20/00

(52) U.S. Cl. CPC G06N 20/00

(57) ABSTRACT

An information processing apparatus for determining an evaluator to evaluate a product or service provided by one of providers from among a plurality of evaluators, the information processing apparatus comprises a controller configured to execute: training a user model, with first data about the providers and second data about the plurality of evaluators who have made evaluations of products or services provided by the providers in past as input data, and third data indicating degrees of usefulness of the evaluations made by the plurality of evaluators in the past as output data; and selecting the evaluator suitable for the one of the providers from among the plurality of evaluators by using the user model.

### CROSS REFERENCE TO THE RELATED APPLICATION

This application claims the benefit of Japanese Patent Application No. 2023-076104, filed on May 2, 2023, which is hereby incorporated by reference herein in its entirety.

### BACKGROUND

### Technical Field

The present disclosure relates to evaluation of a product or service.

### Description of the Related Art

There is known a system for evaluating staff.

For example, Japanese Patent Laid-Open No. 2002-099652 discloses an invention about a system for managing a staff list based on degrees of technical proficiency and extracting a staff member with skills corresponding to a customer's request.

### SUMMARY

An object of the present disclosure is to appropriately select an evaluator to evaluate a product or service.

The present disclosure in its one aspect provides an information processing apparatus for determining an evaluator to evaluate a product or service provided by one of providers from among a plurality of evaluators, the information processing apparatus comprising a controller configured to execute: training a user model, with first data about the providers and second data about the plurality of evaluators who have made evaluations of products or services provided by the providers in past as input data, and third data indicating degrees of usefulness of the evaluations made by the plurality of evaluators in the past as output data; and selecting the evaluator suitable for the one of the providers from among the plurality of evaluators by using the user model.

As another aspect, a method executed by the above information processing apparatus, a program for causing a computer to execute the method, or a computer-readable storage medium that non-transiently stores the program can be given.

According to the present disclosure, it is possible to appropriately select an evaluator to evaluate a product or service.

### BRIEF DESCRIPTION OF THE DRAWINGS

FIG. 1 is a diagram for illustrating an overview of a system according to an embodiment;

FIG. 2 is a diagram illustrating a module configuration of a server apparatus 1;

FIGS. 3A to 3D are diagrams for illustrating data stored in a storage 12;

FIG. 4 is a diagram for illustrating a flow of a process in a controller 11;

FIG. 5 is a flowchart of a process executed by the server apparatus 1; and

FIG. 6 is a flowchart of a process executed by the server apparatus 1.

### DESCRIPTION OF THE EMBODIMENTS

There is known a system for a third person to evaluate a product or service provided by a provider. For example, when a provider starts provision of a new product or service, it is possible to improve the completeness of the product or service by causing a third person to use the product or service beforehand and feed back an evaluation.

In the description below, a person who provides a product or service will be referred to as “a servicer” or “a provider,” and a person who evaluates the product or service will be referred to as “a tester” or “an evaluator.”

In the case of evaluating a product or service by a tester, it is necessary to select an appropriate tester.

Conventionally, a method of selecting a tester based on the tester's attribute such as the tester's taste or and specialty has been used. There may, however, occur a case where it is not possible to select an appropriate tester, depending on the attributes of a target product or service.

For example, when an evaluation target product is food material, it is conceivable to select a tester among persons having the attribute of “being good at cooking.” When the evaluation target product is kelp, however, a tester who does not have a habit of usually making soup stock should not be selected even if the tester is good at cooking.

Thus, in the case of a method of selecting a tester based on a single attribute (for example, specialties) as has been conventionally performed, there may occur a case where it is not possible to select an effective tester.

An information processing apparatus according to the present embodiments solves such a problem.

An information processing apparatus according to one embodiment is an information processing apparatus for deciding an evaluator to evaluate a product or service provided by one of providers from among a plurality of evaluators.

Specifically, the information processing apparatus includes a controller that executes: training a user model, with first data about the providers and second data about the plurality of evaluators who have made evaluations of products or services provided by the providers in past as input data, and third data indicating degrees of usefulness of the evaluations made by the plurality of evaluators in the past as output data; and selecting the evaluator suitable for the one of the providers from among the plurality of evaluators by using the user model.

The provider is a person who provides a target product or service. The provider is typically a developer or inventor of the product but may be a business entity.

The first data is data about providers (servicers), and the second data is data about evaluators (testers).

The first data is, for example, sets of a plurality of attributes of the providers. As attributes of each provider, for example, the business category of the provider and the category of a product or service provided by the provider can be exemplified.

The second data is, for example, sets of a plurality of attributes of the evaluators. As the attributes of each evaluator, for example, the academic background, occupation, field of expertise, interests, tastes, and activity history in the past (visited spots and the like) can be exemplified.

The third data is data indicating degrees of usefulness of evaluations made by the evaluators. For example, it is assumed that, as a result of a certain evaluator evaluating a certain product or service in the past, information useful to a provider could be left. In this case, the third data is data to the effect that “an evaluation with a high degree of usefulness could be left.”

The degrees of usefulness indicated by the third data may be calculated based on predetermined data. For example, it is assumed that a provider attempted to improve a product or service provided by the provider according to an evaluation made by an evaluator. As a result, sales or profits have changed. In this case, the amount of the change in the sales or profits can be a degree of usefulness of the evaluation.

Each of the degrees of usefulness may be a value calculated based on a predetermined criterion (for example, the amount of sales or profits described before) or a score given by a provider to an evaluation made by an evaluator.

The controller generates a user model, with the first to third data as learning data. For example, the user model is a model which, when data about attributes of a provider and of evaluators are inputted, outputs predicted degrees of usefulness of evaluations.

Whether an evaluator can leave an effective evaluation or not can change depending on whether attributes (for example, the field of expertise) of the evaluator match attributes of an evaluator expected by a provider or not. Therefore, the user model learns, for a specific provider, a relationship between attributes of evaluators and degrees of usefulness of evaluations made by the evaluators in the past. The user model can also be said to be a model that outputs degrees of usefulness of evaluations made by evaluators to a provider (so to speak, compatibility between the provider and the evaluators).

By using the user model, it is possible to predict, for each of the plurality of evaluators, how effective an evaluation obtained from the evaluator is. Further, it becomes possible to perform screening for evaluators from whom more effective evaluations can be expected.

Embodiments of the present disclosure will be described below based on the drawings. The configurations of the following embodiments are exemplifications, and the present disclosure is not limited to the configurations of the embodiments.

### First Embodiment

An overview of a server apparatus according to a first embodiment will be described. The server apparatus according to the present embodiment is an apparatus that, for a provider who provides a product or service, selects evaluators to evaluate the product or service.

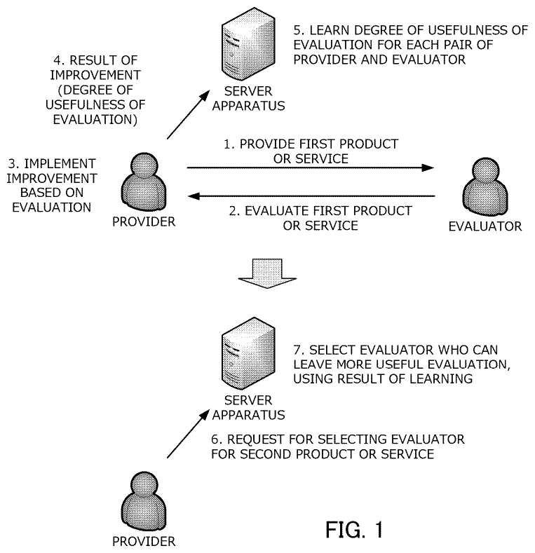

An overview of a process performed by the server apparatus will be described with reference to FIG. 1.

First, a provider provides a first product or service to an evaluator, and the evaluator evaluates the first product or service. The evaluator feeds back an evaluation result to the provider. The evaluation result includes an impression of using the first product or service, an improvement proposal, and the like.

The provider who receives the evaluation result implements the improvement of the first product or service according to the content of the evaluation.

Whether the evaluation made by the evaluator is useful to the provider or not can be known from a result of implementing the improvement of the product or service according to the content of the evaluation. For example, if sales of the product or service increased as a result of improving the product or service according to the improvement proposal included in the evaluation, it can be said that the evaluation was useful to the provider.

In the present embodiment, the provider transmits the result of the improvement (that is, information for determining a degree of usefulness of the evaluation) to the server apparatus, and the server apparatus learns the degree of usefulness of the evaluation based thereon. The server apparatus learns, for example, a relationship among a plurality of attributes of the provider, a plurality of attributes of the evaluator, and the degree of usefulness of the evaluation, using a machine learning model.

Here, a case will be considered where the provider releases a second product or service following the first product or service. In this case, it is preferable that the provider selects an evaluator who makes a more useful evaluation for the second product or service. In the present embodiment, the server apparatus selects evaluators predicted to be able to leave evaluations useful to the provider, by using the learned machine learning model. Thereby, it becomes possible to provide the provider with information such as “which evaluator is to be requested to make an evaluation in order that a more useful evaluation is obtained”.

### [Apparatus Configuration]

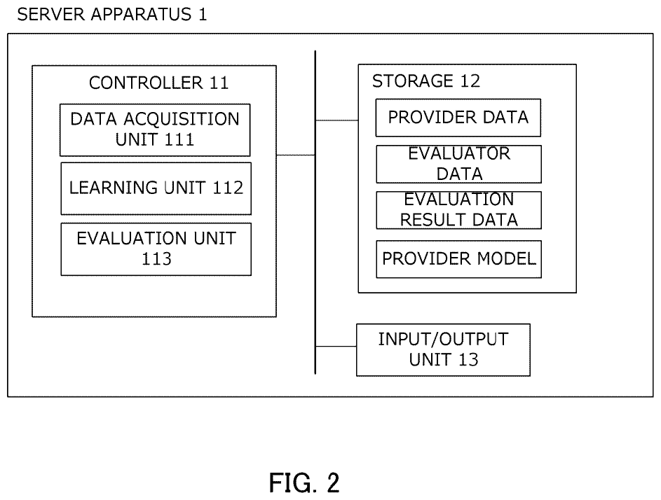

FIG. 2 is a diagram illustrating an example of a configuration of a server apparatus 1.

The server apparatus 1 is a computer, for example, a server apparatus, a personal computer, a smartphone, a mobile phone, a tablet computer, or a personal information terminal. The server apparatus 1 is configured including a controller 11, a storage 12, and an input/output unit 13.

The server apparatus 1 performs learning of a machine learning model, with data about providers, data about evaluators, and degrees of usefulness of evaluations made by the evaluators in the past as learning data. Further, for a certain provider, the server apparatus 1 selects evaluators who can make useful evaluations, using the learned machine learning model.

The server apparatus 1 can be configured as a computer including a processor (a CPU, a GPU, or the like), main memories (a RAM, a ROM, and the like), auxiliary storage devices (an EPROM, a hard disk drive, a removable medium, and the like). In the auxiliary storage device, an operating system (OS), various kinds of programs, various kinds of tables, and the like are stored. By executing a program stored therein, each of functions (software modules) that meet predetermined purposes as described later can be realized. A part or all of the functions, however, may be realized as hardware modules by a hardware circuit like an ASIC and an FPGA.

The controller 11 is an arithmetic unit that realizes various kinds of functions of the server apparatus 1 by executing a predetermined program. The controller 11 can be realized, for example, by a hardware processor such as a CPU. The controller 11 may be configured including a RAM, a ROM (read-only memory), a cache memory, and the like.

The controller 11 is configured including three software modules, a data acquisition unit 111, a learning unit 112, and an evaluation unit 113. Each of the software modules may be realized by executing the program stored in the storage 12 described later by the controller 11 (the CPU).

The data acquisition unit 111 acquires data for causing the machine learning model to perform learning (learning data). In the present embodiment, the learning data includes three kinds of data, data about providers (provider data), data about evaluators (evaluator data), and data indicating degrees of usefulness of evaluations made by the evaluators in the past (evaluation result data).

The provider data is sets of a plurality of attributes about the providers. The provider data may include attributes and the like of products or services provided by the providers, in addition to attributes of the provider. The provider data may include a user identifier of each provider, a category (field) of the product or service provided by the provider, a business category, and the like. In the description below, the sets of the plurality of attributes will be referred to as pieces of attribute information.

The provider data may be generated by the data acquisition unit 111 based on the pieces of attribute information about the providers inputted by the providers themselves or may be acquired from another apparatus that manages user information.

The evaluator data is sets of a plurality of attributes about the evaluators. The evaluator data includes attributes of the evaluators themselves. The evaluator data may include, for example, a user identifier of each evaluator, personal information (gender, age, academic background, and the like) about each evaluator, the field of expertise, specialty, tastes, and fields of interest of each evaluator, a character evaluation of each evaluator, and data about the personal trend of each evaluator. The evaluator data may be generated by the data acquisition unit 111 based on pieces of attribute information about the evaluators inputted by the evaluators themselves or third persons, or may be acquired from another apparatus that manages user information. As the data inputted by third persons, specialty, character evaluations, and the like of the evaluators can be exemplified.

The evaluation result data is data indicating degrees of usefulness of evaluations made by specific evaluators for products or services provided by specific providers. For example, it is assumed that a certain evaluator evaluated a certain product or service in the past, and a provider attempted to improve the product or service according thereto. As a result, if sales, price per customer, profits, or the like has increased, it can be said that the evaluation is useful to the provider.

The data acquisition unit 111 may directly import the evaluation result data or generate the evaluation result data based on data about evaluations made in the past.

For example, the data acquisition unit 111 can acquire histories about results of providers attempting to improve products or services according to improvement proposals included in evaluations made by specific evaluators in the past (hereinafter referred to as pieces of improvement history data), calculate degrees of usefulness of evaluations based thereon, and then generate the evaluation result data. Each piece of improvement history data may be, for example, data showing a transition or the like in sales or profits of the product or service from before to after an improvement proposal. The pieces of improvement history data may be inputted by the providers via the input/output unit 13.

In the present embodiment, the evaluation result data includes values indicating degrees of usefulness of evaluations. The values can be, for example, dimensionless numbers obtained by normalizing the degrees of usefulness of the evaluations to be within a predetermined range.

The learning unit 112 causes the machine learning model (an example of a user model; hereinafter referred to as a provider model) to learn with attributes (attributes of the providers and attributes of the evaluators) included in the data acquired by the data acquisition unit 111 and the degrees of usefulness of the evaluations as learning data. The provider model is stored in the storage 12 described later. By the learning unit 112 executing learning, the machine learning model which has learned relationships among the attributes of the providers, the attributes of the evaluators, and the degrees of usefulness of the evaluations is obtained.

The evaluation unit 113 selects evaluators expected to leave evaluations useful to a specific provider, using the learned provider model. Specifically, for the target provider, the evaluation unit 113 generates combinations between the provider and the plurality of evaluators registered with the system, inputs, for each of the combinations, attributes of the provider and attributes of an evaluator to the provider model, and acquires predicted values of degrees of usefulness of evaluations as an output. The evaluation unit 113 outputs information about such evaluators that the predicted degrees of usefulness of evaluations are above a predetermined value.

The storage 12 is a unit for storing information and is configured with a storage medium such as a RAM, a magnetic disk, or a flash memory. In the storage 12, a program executed by the controller 11, and data and the like used by the program are stored.

In the storage 12, the provider data, the evaluator data, and the evaluation result data that are acquired by the data acquisition unit 111, and the provider model are stored.

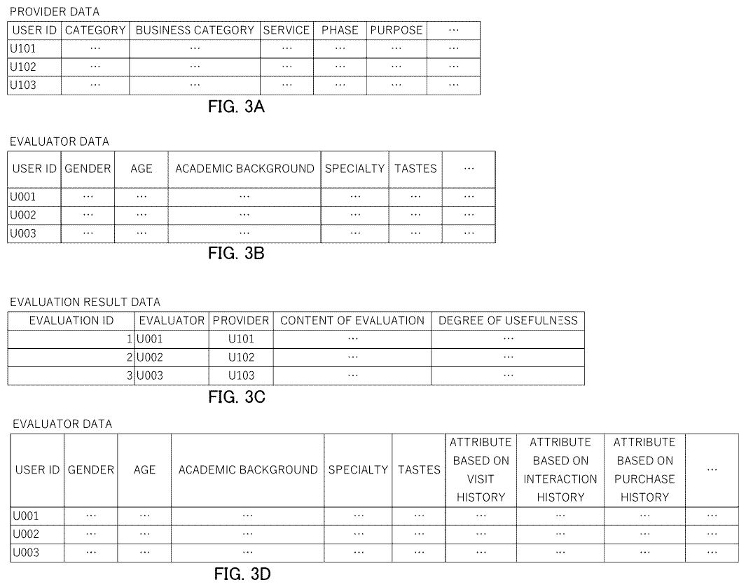

Here, examples of the provider data, the evaluator data, and the evaluation result data will be described. FIG. 3A illustrates an example of the provider data.

The provider data includes sets of a plurality of attributes about providers. In the illustrated example, the provider data includes, for each provider, a user identifier (a user ID), and data about a category to which a product or service provided by the provider belongs, the business category, the type of the service, the phase, the purpose, and the like. The data may be inputted by the providers.

FIG. 3B illustrates an example of the evaluator data.

The evaluator data includes sets of a plurality of attributes about evaluators. In the illustrated example, the evaluator data includes, for each evaluator, a user identifier (a user ID) and data about the gender, age, academic background, specialty, tastes, and the like of the evaluator. Data other than the exemplified data may be included in the evaluator data if the data relates to attributes of the evaluators. For example, personal interests, trends, schedules (conditions for participating in evaluation), remuneration, and the like may be included in the evaluator data. Further, for example, by causing third persons to evaluate the characteristics of the evaluators (intimacy, personality, human relationships, character, and the like), evaluation results may be included in the evaluator data.

FIG. 3C illustrates an example of the evaluation result data.

The evaluation result data is data indicating degrees of usefulness of evaluations made by evaluators in the past as described before. In the illustrated example, the evaluation result data includes, for each evaluation made in the past, an evaluation identifier (an evaluation ID), a user ID of an evaluator, a user ID of a provider, content of the evaluation, and a degree of usefulness. The degree of usefulness may be a dimensionless number or a numerical value related to usefulness of the evaluation if it is a numerical value indicating usefulness of the evaluation. The degree of usefulness may be calculated by the data acquisition unit 111 based on each piece of improvement history data or may be a score given by each provider himself.

FIG. 3D will be described later in a second embodiment.

Returning to FIG. 2, the description will be continued.

The input/output unit 13 is a unit for accepting an input operation performed by an operator and presenting information to the operator. Specifically, the input/output unit 13 includes a device for performing input such as a mouse and a keyboard, and a device for performing output such as a display and a speaker. The input and output devices may be integrally configured, for example, with a touch panel display.

As for a specific hardware configuration of the server apparatus 1, components can be appropriately omitted, replaced, and added according to each embodiment. For example, the controller 11 may include a plurality of hardware processors. The hardware processors may be configured with a microprocessor, an FPGA, a GPU, and the like. Further, input and output devices other than the exemplified ones (for example, an optical drive) may be added. Further, the server apparatus 1 may be configured with a plurality of computers. In this case, the hardware configurations of the computers may be the same or not the same.

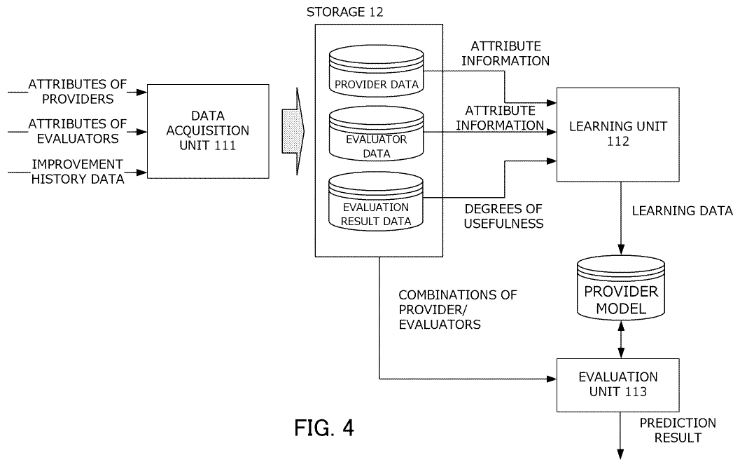

Next, a flow of a process performed by the controller 11 of the server apparatus 1 will be described with reference to FIG. 4.

First, the data acquisition unit 111 acquires data required to generate the provider data, the evaluator data, and the evaluation result data.

In the present embodiment, the data acquisition unit 111 acquires data about attributes of a target provider and generates the provider data illustrated in FIG. 3A based on the data. At this time, the data may be converted or integrated. The data acquisition unit 111 may accept input of the data via the input/output unit 13. The data acquisition unit 111 may directly acquire the provider data via the input/output unit 13.

Further, the data acquisition unit 111 acquires data about attributes of evaluators and generates the evaluator data illustrated in FIG. 3B based on the data. At this time, the data may be converted or integrated. The data acquisition unit 111 may accept input of the data via the input/output unit 13. The data acquisition unit 111 may directly acquire the evaluator data via the input/output unit 13. Furthermore, the data acquisition unit 111 may acquire a part of the data for generating the evaluator data from an external apparatus.

Further, the data acquisition unit 111 acquires the pieces of improvement history data described before, calculates degrees of usefulness of evaluations based on the pieces of improvement history data, and then generates the evaluation result data. Each piece of improvement history data may include, for example, a numerical value that can be used to evaluate a degree of usefulness (for example, an amount or rate of change in the amount of sales or profits from before to after improvement). The pieces of improvement history data may be received from external apparatuses such as sales management servers. The data acquisition unit 111 may cause the provider to directly input degrees of usefulness via the input/output unit 13.

By storing data to be a criterion for calculating degrees of usefulness in the storage 12, the data acquisition unit 111 may calculate degrees of usefulness using the data.

As examples of the criterion, the following are given:
The more the amount of sales increases from before to after improvement, the higher a degree of usefulness is calculated.
The more the amount of profits increases from before to after improvement, the higher a degree of usefulness is calculated.
The more the number of customers increases from before to after improvement, the higher a degree of usefulness is calculated.
The more the degree of customer satisfaction increases from before to after improvement, the higher a degree of usefulness is calculated.

Though a transition or the like in sales or profits of a product or service from before to after an improvement proposal is exemplified as the data for calculating a degree of usefulness of an evaluation in the present embodiment, the degree of usefulness of an evaluation may be calculated using other criteria.

The degree of usefulness of an evaluation indicates how affirmative a result of a provider receiving the evaluation is. Therefore, if it is possible to calculate how affirmative a result of a provider receiving an evaluation is, the indicator is not necessarily an amount of money or the like.

Further, the degree of usefulness may be calculated based on elements other than commercial elements. For example, if the skill or ability of a provider is improved by receiving an evaluation, the degree of usefulness of the evaluation may be set higher on the assumption that an affirmative result has been obtained.

The provider data, the evaluator data, and the evaluation result data generated by the data acquisition unit 111 are stored in the storage 12.

Next, the learning unit 112 performs learning of the provider model based on the stored three kinds of data. The learning unit 112 extracts a corresponding plurality of pieces of attribute information from the provider data and the evaluator data to generate input data, and extracts degrees of usefulness from the evaluation result data to generate output data. Further, the learning unit 112 causes the provider model to perform learning, with the input and output data as learning data. Input of learning data may be repeatedly performed in predetermined cycles. Thereby, it is possible to obtain such a provider model that, when the plurality of attributes of the provider and the plurality of attributes of the evaluators are inputted, outputs predicted values of degrees of usefulness of evaluations.

With an instruction from the operator of the server apparatus 1 as a trigger, the evaluation unit 113 selects evaluators suitable for a specific provider. The evaluation unit 113 causes the operator to specify the target provider and extracts corresponding records from the provider data. Further, the evaluation unit 113 extracts records of a plurality of evaluators who can be combined with the target provider (that is, evaluator candidates) from the evaluator data. For each of combinations between the provider and the evaluators, the evaluation unit 113 inputs attribute information about the provider and the evaluator to the provider model and acquires a predicted value of a degree of usefulness as an output. Thereby, the predicted value of the degree of usefulness is obtained for each of the evaluator candidates. Then, for such evaluators that the obtained degrees of usefulness of evaluations exceed a predetermined value, the evaluation unit 113 outputs information about them.

### [Flowchart]

Next, a process executed by the server apparatus 1 according to the present embodiment will be described.

The process executed by the server apparatus 1 can be divided into a phase of causing the provider model to perform learning (a learning phase) and a phase of performing prediction based on the learned provider model (a prediction phase).

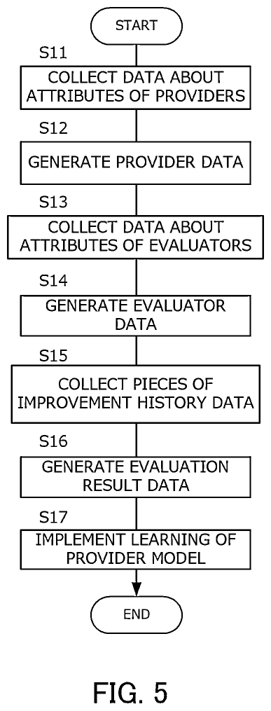

FIG. 5 is a flowchart of the learning phase executed by the server apparatus 1. The illustrated process is started by an operation of the operator of the server apparatus 1.

First, at step S11, the data acquisition unit 111 collects data about attributes of providers. The data may be acquired via the input/output unit 13 or from an external apparatus. Next, at step S12, the data acquisition unit 111 generates provider data as described with reference to FIG. 3A, based on the collected data. The provider data is generated for all the providers for whom the data about attributes has been collected.

At step S13, the data acquisition unit 111 collects data about attributes of evaluators. The data may be acquired via the input/output unit 13 or from an external apparatus. Next, at step S14, the data acquisition unit 111 generates evaluator data as described with reference to FIG. 3B, based on the collected data. The evaluator data is generated for all the evaluators for whom the data about attributes has been collected.

Next, at step S15, the data acquisition unit 111 acquires pieces of improvement history data. As described before, the pieces of improvement history data are histories about results of the providers improving products or services according to improvement proposals included in evaluations made by specific evaluators in the past. Each piece of improvement history data may include identifiers of an evaluator, a provider, and a target product or service, content of an improvement proposal, and a result of improvement (a transition or the like in sales or profits of the product or service). Each piece of improvement history data may include a plurality of records.

Next, at step S16, the data acquisition unit 111 generates evaluation result data based on the pieces of improvement history data. At this step, the data acquisition unit 111 calculates degrees of usefulness based on the acquired improvement history data (improvement results), and then generates the evaluation result data as described with reference to FIG. 3C.

Next, at step S17, the learning unit 112 performs learning of the provider model based on the evaluator data, the provider data, and the evaluation result data (the degrees of usefulness). For example, the learning unit 112 performs learning of the provider model by converting values stored in a plurality of fields included in each of the pieces of data to feature values and inputting the feature values to the provider model as learning data. Thereby, it is possible to cause the provider model to learn a relationship about, for a specific provider, an evaluator with what attributes being able to leave an evaluation with what degree of usefulness.

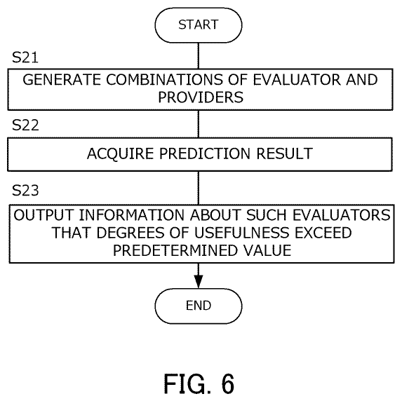

FIG. 6 is a flowchart of the prediction phase executed by the server apparatus 1. The illustrated process is started by an operation of the operator of the server apparatus 1.

First, at step S21, the evaluation unit 113 generates combinations between evaluators and a provider. At this step, information specifying the target provider is acquired via the input/output unit 13, and then evaluator candidates are acquired. The evaluator candidates may be obtained by performing filtering with minimum conditions (for example, conditions presented by the provider).

Next, at step S22, for each combination of an evaluator and the provider, the evaluation unit 113 inputs attribution information corresponding to the evaluator and the provider to the provider model and acquires a predicted value of a degree of usefulness as an output. By this step, predicted values of degrees of usefulness for the combinations between the evaluators and the provider can be obtained.

Next, at step S23, the evaluation unit 113 selects such evaluators that predicted values of degrees of usefulness exceed a predetermined value, and outputs information related to the evaluators (for example, user IDs, personal information, and contact addresses) as evaluators suitable for the target provider.

As described above, the server apparatus according to the present embodiment learns a provider model, with degrees of usefulness of evaluations made by evaluators in the past as learning data, and selects evaluators for evaluating a new product or service using the provider model. In general, whether or not a certain evaluator can leave a useful evaluation for a product or service can change depending on whether the evaluator has attributes expected by a provider. Since the server apparatus according to the present embodiment performs learning using attributes of evaluators, it becomes possible to select evaluators with attributes suitable for a provider.

### Second Embodiment

In the first embodiment, learning of the provider model is performed using information such as specialty and tastes of evaluators. Learning of the provider model, however, can also be performed using other information. A second embodiment is an embodiment in which learning of a provider model is executed further using data about past activities of evaluators.

For example, if an evaluator visited a certain spot (for example, a stadium) many times in the past, the evaluator can be regarded as having an attribute related to the spot (for example, the attribute of being a baseball fan). In the second embodiment, the server apparatus 1 acquires activity histories of evaluators in the past and performs learning of a provider model based on the obtained data.

In the second embodiment, the data acquisition unit 111 is configured to be capable of acquiring, for each of a plurality of evaluator, data about an activity history in the past (hereinafter referred to as a piece of activity history data).

The piece of activity history data is data about a history of activities taken by each of the evaluators. As such data, a history of position information about a mobile terminal carried by the evaluator, a history of browsing of websites by the evaluator, a history of online purchase of goods by the evaluator, and the like are given. The piece of activity history data may be acquired from a terminal (such as a smartphone) related to each evaluator or may be acquired from an external apparatus that manages terminal location histories, website access logs, good purchase histories, or the like.

In the second embodiment, the data acquisition unit 111 identifies spots that the evaluators visited in the past, targets that the evaluators interacted with online, goods that the evaluators purchased in the past, and the like based on the acquired pieces of activity history data. Further, additional attributes of the evaluators are decided based on the visited spots, the interaction targets, the purchased goods, and the like that have been identified.

FIG. 3D illustrates an example of the evaluator data in the second embodiment. In the second embodiment, the evaluator data further includes an attribute based on a visit history, an attribute based on an interaction history, and an attribute based on a purchase history.

The attribute based on the visit history is an attribute based on spots visited by each evaluator in the past. The attribute based on the interaction history is an attribute based on targets interacted with by each evaluator in the past. The attribute based on the purchase history is an attribute based on goods purchased by each evaluator in the past. These attributes may be obtained, for example, by classifying sets of visited spots, interaction targets, purchased goods, and the like into classes by a machine learning model.

For example, if an evaluator has visited shops related to automobiles and interacted with webpages related to automobiles, the evaluator can be given the attribute of “having deep knowledge about automobiles.”

In the second embodiment, the learning unit 112 and the evaluation unit 113 perform learning of the provider model and prediction, using the additional attributes described above in addition to the attributes described in the first embodiment. According to such a configuration, it becomes possible to improve the accuracy of prediction more.

### Modification

The above embodiments are mere examples, and the present disclosure can be appropriately changed and implemented within a range not departing from its spirit.

For example, the processes and means described in the present disclosure can be freely combined and implemented as far as technical contradiction does not occur.

Further, though the pieces of attribute information about the providers and the evaluators are used as learning data in the description of the embodiments, other data may be used as learning data as far as the data relates to the providers and the evaluators.

Further, a process described as being performed by one apparatus may be shared and executed by a plurality of apparatuses. Or alternatively, processes described as being performed by different apparatuses may be executed by one apparatus. In a computer system, what hardware configuration (server configuration) each function is realized by can be flexibly changed.

The present disclosure can be realized by supplying a computer program implemented with the functions described in the above embodiments to a computer, and one or more processors included in the computer reading out and executing the program. Such a computer program may be provided for the computer by a non-transitory computer-readable storage medium connectable to a system bus of the computer or may be provided for the computer via a network. As the non-transitory computer-readable storage medium, for example, any type of disk/disc such as a magnetic disk (a floppy (registered trademark) disk, a hard disk drive ((HDD), or the like) and an optical disc (a CD-ROM, a DVD disc, a Blu-ray disc, or the like), a read-only memory (ROM), a random-access memory (RAM), an EPROM, an EEPROM, a magnetic card, a flash memory, an optical card, and any type of medium that is appropriate for storing electronic commands are included.

What is claimed is:

1. An information processing apparatus for determining an evaluator to evaluate a product or service provided by one of providers from among a plurality of evaluators, the information processing apparatus comprising a controller configured to execute:
training a user model, with first data about the providers and second data about the plurality of evaluators who have made evaluations of products or services provided by the providers in past as input data, and third data indicating degrees of usefulness of the evaluations made by the plurality of evaluators in the past as output data; and
selecting the evaluator suitable for the one of the providers from among the plurality of evaluators by using the user model.

2. The information processing apparatus according to claim 1, wherein
the degrees of usefulness are values calculated based on results of the providers attempting to improve the products or services provided by the providers in the past, based on the evaluations made by the plurality of evaluators in the past.

3. The information processing apparatus according to claim 1, wherein
the degrees of usefulness are scores given by the providers to the evaluations made by the plurality of evaluators in the past.

4. The information processing apparatus according to claim 1, wherein
the second data is sets of a plurality of attributes of the each of the plurality of evaluators.

5. The information processing apparatus according to claim 1, wherein
the user model is a model configured to, when the first data and the second data are inputted, output predicted values of degrees of usefulness of evaluations made by the plurality of evaluators to the one of the providers.
